(19) United States
(12) Patent Application Publication
(10) Pub. No.: US 2002/0035432 A1
(43) Pub. Date: Mar. 21, 2002

(54) Method and system for spatially indexing land

(76) Inventors: Boguslaw Kubica, Atlanta, GA (US); Craig W. Robertson, Lexington, KY (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/878,149

(22) Filed: Jun. 8, 2001

Related U.S. Application Data
(60) Provisional application No. 60/210,268, filed on Jun. 8, 2000.

(51) Int. Cl. G06F 19/00

(52) U.S. Cl. 702/5

(57) ABSTRACT

A method of spatially indexing land by selecting a parcel (100) of land and extending its boundaries (110) to include a portion of adjacent streets (125) and alleys (122) to define a cell (150). A unique identifier is assigned to the cell as well as a reference point (170) within the cell (150). The reference point has a known location in a global referencing system. An internet address is assigned to the cell which identifies its location, such as the location of the reference point within the cell. This information and other data associated with the cell is then stored in an OX Spatial Index database and includes the street address for the cell and other relevant information such as owner, what type building if any is on the property, location of utility lines, etc. A Spatial Internet Address which includes the geographic location of the cell is assigned for each cell and this information is also stored in the index. The index thereby created can be used for various applications such as determining a user's location and locating geographically relevant information by searching the index and connecting to websites associated with the user's vicinity.

### CROSS REFERENCE TO RELATED APPLICATION

This patent application claims the priority of U.S. Provisional Patent Application No. 60/210268 filed Jun. 8, 2000.

### FIELD OF THE INVENTION

The present invention relates to a system and method for spatially indexing land and providing location services.

### BACKGROUND OF THE INVENTION

The physical location and the metes and bounds or legal description of a parcel of land can now be determined with great accuracy. However, such a precise description conveys only the physical location of boundaries, and little else. Further, such descriptions are generally only useful to land surveyors or others with the instruments needed to locate the referenced markers and measure out the parcel. Tax collectors and assessors generally use a different system, such as parcel ID numbers. Utilities typically use still other systems, some of which are proprietary or are utility specific.

Thus, a particular parcel of land may have several different reference identifications, such as parcel id, plat book number, etc., all of which provide valuable information but none of which are readily useful or understood by the general public. Thus, the general public typically uses yet another, more widely known system for locating places: a street address, such as a street name and building number. A street address, however, does not provide other valuable parcel information such as the boundaries of the land, location of easements, etc.

Different users use different maps and referencing systems which contain different information. For example, a water utility may know the location of its underground lines for a particular area from its proprietary map and a gas utility may know the location of its underground lines from a different proprietary map. Thus, these utilities are not viewing the same page or even the same document, so it is difficult to reconcile the information from one map with another map. With disparate maps, referencing systems and data sources, there is no convenient means by which different users can access, share, store and update information with each other. For example, a company wanting to lay fiber optic cable would need to know the location of water and gas lines prior to performing work on the property. This company would have to go to each utility (water, gas) to obtain the relevant maps and then reconcile these two different maps. This company would then most likely record the location of the fiber optic cable on yet another map: its own map. It will be understood that the terms “map” and “database” may be used interchangeably and mean the stored data for such systems which may be shown in the format of a map.

In addition, the various referencing systems used are rarely coordinated, and are generally incompatible. For example, searching for the metes and bounds description of a parcel may not be an option supported by a tax assessor's information, documents, or program, so the parcel ID number could not be determined. Also, the general public would want a street address, and would have no use for a metes and bounds description or a parcel ID number when trying to locate a business.

Geospatial Information Systems (GIS) have been developed which capture, store, check, integrate, manipulate, analyze and display data related to positions on the Earth's surface. Typically, a GIS is used for coordinating different maps so that they may be represented as several different “layers” where each layer contains data about a particular kind of feature. Each feature is linked to a position on a graphical image of a map.

A typical prior art parcel-based GIS would provide information associated with a parcel but does not include reference information regarding areas located outside the parcel, such as streets, alleys, etc. and therefore relate only to the parcel per se. Although streets, alleys, and other “outside” areas may not be part of the usable parcel of land, they may relate to valuable information such as utilities, easements, etc. If two adjacent parcels under these prior art GIS systems are combined then, if there is a street between these two parcels, a void is created where the street or other outside area is located and this valuable “outside” information is lost. Thus, such prior art parcel systems do not cover 100% of the earth's surface or even 100% of some tracts of land.

Global referencing systems, such as Global Positioning System (GPS), the World Geodetic System, and the Military Grid System have been developed which cover 100% of the earth's surface. However, although most people know the street address of their home, they do not know the address in a global referencing system. Thus, although such prior art systems may cover all of the earth's surface, they are neither readily understandable nor useable by the average person.

Attempts have been made to develop local referencing systems which are cross referenced with global systems. For example, U.S. Pat. No. 5,839,088 discloses creating a local location reference address associated with a global referencing system. That method, however, uses proprietary local addresses which are not based upon parcels or street addresses. Thus, valuable information associated with individual parcels is not available and the information may only be useable by a select group of persons.

Many diverse GIS systems currently exist which contain valuable information. However, evolving geospatial technology has led to a fragmentation of this information effectively creating disconnected islands of information. New systems are constantly being developed which are incompatible with old systems. Due to the valuable information contained in the old systems and the constant update of such systems, it is not economically feasible to stop development of the old systems for the time needed to correct them or make them compatible with the new systems. Thus, the disparities between the databases of these systems continue to grow and the ability to conflate these databases continues to decrease.

Many of these systems are relative positioning systems which are very accurate in regards to the relationships between objects or features but which are less accurate in regards to absolute positioning. For example, the map used by a telephone utility may be based upon the relative position of utility poles to a known object and the map of an electric power utility may be based upon the relationships between the utility poles. While these systems may be very accurate in a relational sense they are typically less accurate in an absolute positioning sense. Therefore, problems arise when one relative positioning based map is overlaid another due to these absolute positioning inaccuracies.

Another problem with prior art GISs is that it is difficult to determine whether the information provided is accurate or current. For example, many systems are updated only upon the occurrence of a particular event relevant to the provider of the information, such as the sale or subdivision of the land, the installation of a particular utility service, etc. Thus, one parcel upon which this event has recently occurred may have information only days or weeks old whereas the information for an adjacent parcel may be decades or a century or more old. Other systems are only updated periodically. Thus, if major changes occur between updating periods, such as the building of a subdivision on a parcel, this information will not be incorporated until the next update. Thus, a user may be provided information that is current, or information that has not been updated since the 1800's. Compounding the problem is that these systems do not provide data regarding the quality of the information, such as when the information was last updated and the source of the updated information. Thus, the user does not know how current the information is, or its source, and therefore cannot make a determination of its quality or whether to rely on the data.

In addition, when an event occurs old records are typically replaced with new records so it is often difficult to obtain historical information for a piece of property. For example, a potential buyer of a property may want to know what prior uses were approved for the property but may only be able to obtain information as to currently approved uses, or the uses approved as of the last update of the information. In many cases, the historical data, such as whether the site was once available for storage, handling, or disposal of toxic materials can be more important than current data, such as that the site is being used as a golf course.

In addition, even when accurate geospatial information is provided the prior art does not make the information conveniently available to users to access and update the information or to manipulate the information based upon a user's present location. Recent advances in technology now allow a person's present physical location to be readily determined. For example, GPS systems are often used in automobiles, and mobile phone providers often use triangulation methods, to determine a user's physical location. However, the prior art has not attempted to associate a particular geographic area with an internet protocol (IP) address and vice versa.

When a user connects to the internet, the user's IP address can be easily determined by known methods. IP addresses are currently formatted in 32 bit Ipv4 format. These addresses are typically written as four numbers ranging from 0 to 255 which are separated by periods and which are used in different ways to identify a particular network and a host on that network. These addresses are often converted into letters for easier reading by humans. There are a limited number of ipv4 IP addresses and the supply of available addresses is rapidly being depleted.

A conventional IP address does not contain geographic information. Thus, geographic associations cannot be made from an IP address, such as determining a physical location associated with or based upon an IP address, determining IP addresses which are relevant to a person's location, or determining the geographic distance between two internet addresses.

Thus, there is a need for a method and system of spatially indexing land which covers the entire earth's surface.

There is also a need for a method and system of spatially indexing land which is easily understandable by a variety of users.

There is also a need for a convenient and inexpensive way to reconcile and identify errors in existing relative positioning databases.

There is also a need for a method and system of spatially indexing land which allows for easy storage, access and updating of data.

There is also a need for a method and system which provides information on the quality of geographical data such as the source of the information and the time and date the information was last updated.

There is also a need for a method and system which provides historical data for specific geographic areas.

There is also a need for a system which provides a means for associating a physical location with an internet address.

### SUMMARY OF THE INVENTION

The present invention solves the aforementioned problems by providing a method and system which spatially indexes land, and can cover 100% of the earth's surface, certify the quality of information within the index, provide a means for easily accessing and updating such information, provide historical information, and associate a geographical location with an IP address.

In one embodiment of the invention, the boundaries of a parcel of land are determined from predefined boundaries, such as a tax parcel. The parcel boundaries are then extended to a portion of the adjacent streets to define an OX™ Cell which incorporates a portion of the adjacent streets. OX™ is a trademark of OGETA, Inc. A unique identifier is assigned to the OX Cell. In a preferred embodiment the unique identifier includes attribute data such as the country, state, township, and street address of the parcel. The geographical location of the boundaries of the OX Cell are determined and recorded. A reference point is assigned to the OX Cell. In a preferred embodiment the reference point is located at the center of mass of the cell. However, it may be at any desired location such as the most northwestern point, or the most southern point, etc. The location of the reference point within a global referencing system, the longitude-latitude system in the preferred embodiment, is then determined and recorded. The reference point is then assigned a global reference address which in the preferred embodiment are its coordinates within the global referencing system. In this way, the entire surface of the earth is broken into a plurality of OX Cells, each with its own unique identifier and global reference address and associated attribute data such as a street address. For each cell, the unique identifier, the global reference address, the cell boundaries, the geographic location, the street address and other associated attribute data are recorded and stored to create an OX Spatial Index which is stored in a relational database.

Thus, the present invention treats the street, preferably, but not necessarily, up to the center line, as part of a cell, and stores information about the parcel and the portions of streets and alleys which it adjoins as attribute data for the cell. Thus, when two cells are combined, the combined cells properly reflect the area of the combined parcels, including the adjacent streets, and the attribute data for both cells. In this way, the entire surface of the earth is represented by a plurality of cells, each cell having corresponding and relevant attribute data, such as a street address which is readily understood.

Much of the attribute data may be represented as “layers” on a map, where each layer contains information about a particular kind of feature, such as a road. Each feature is linked to a position on a graphical image of a map. Layers of data are then organized to provide the desired information, and even to provide information for later statistical analysis. For example, one layer in the data may include attribute data regarding the owner of the parcel and could include fields for Name, Address, Contact, Telephone Number, Municipality, Business, etc.

A unique IP address is created for and associated with each cell. This unique IP address is also stored in the OX Spatial Index. Thus, each cell is uniquely associated with an internet address. Therefore, for any IP address an associated geographic location can be identified by using the OX Spatial Index. In addition, the distances between geographic locations associated with the IP addresses can be determined.

In a preferred embodiment the IP address is a Spatial Internet Protocol address (SIP) which is formatted so as to provide a geographical reference location of its associated cell. In a preferred embodiment the SIP includes a top level domain and the longitude-latitude coordinates of a cell's reference point. Thus, geographic locations associated with cells can be determined directly from the SIP without the need of lookup tables in the index.

The OX Spatial Index is made available to users for searching, viewing, editing, and updating and for use by various applications. In a preferred embodiment, the OX Spatial Index is available via the internet. In one embodiment the OX Spatial Index is accessible at a website to which users connect via the internet. A user retrieves data by issuing queries to the OX Spatial Index database such as by inputting a street address, a geographic address, an SIP or some other data. In another embodiment, a website is located at each SIP and data is made available at that website for its associated cell or cells. Thus, a user can view the attribute data for a particular cell at its associated website.

As mentioned above, users can input and update data in the OX Spatial Index. When such updates are made, quality indicia or metadata is recorded, including the source of the data and the time and date the data is input. Thus, for data entered, a user can review quality indicia to help determine whether the data can be relied upon. The quality indicia may also be analyzed to certify the quality of the data. In addition, when the OX Spatial Index is updated the historical information is kept in the index. Thus, a user can obtain historical attribute data as well as current attribute data. To further ensure accuracy of the index, a series of security levels are provided which may place limits on the access granted a user. In addition, the recording of the quality indicia may be automated to store information based upon a user's identification and automatically insert the time and date of the updates. To further ensure the accuracy of the data, a series of data checks may be performed on the data, such as whether the data is compatible with existing data. For example, entering a parcel ID for the first time may not cause a data check alert. However, once a parcel ID is entered, then entering a different parcel ID would cause a data check alert.

In addition, a user can specify when he would like to be notified of particular changes to the index, such as the owner, or a telephone number for the owner, etc. Thus, when an update occurs which meets the criteria set by a user, the user is sent a notification of the update. The user may then review the update for accuracy or for any desired business or other purpose.

Thus, the present invention relates to a method of spatially indexing land information by: selecting a parcel of land; defining a cell to include at least a portion of the parcel; assigning a unique identifier to the cell; establishing a reference point for the cell, the reference point having a locational address within a global referencing system; assigning a global reference address to the cell; assigning an internet address for the cell; and storing the internet address, the unique identifier, the cell boundaries, the locational address and/or other attribute data in an index.

The present invention also relates to a spatial index which provides quality indicia and data certification.

The present invention also relates to a spatial index which provides historical data.

The present invention also relates to various applications which use the aforementioned index. For example, a user's physical location is determined and the user is supplied with geographically relevant information, such as links to websites in the vicinity, advertisements from nearby stores, directions to nearby restaurants, etc. Thus, the OX Spatial Index provides for the economically feasible development and maintenance of comprehensive location-enabled business models.

The present invention also provides a means for reconciling relative positioning databases by providing an absolute positioning “base” database which can be cross-referenced with the relative positioning databases. Various relative positioning systems can then be tied together by reference to the absolute positioning data in the OX Spatial Index. For example, if a telephone utility uses a relative positioning system of utility poles and an electric utility uses a different positioning system for the utility poles, both of these different referencing systems can be separately cross referenced to the OX Spatial Index. Because the OX Spatial Index contains information regarding each pole and its absolute position, the maps of both the telephone and power utilities can be referenced to the index and the errors or differences determined. Thus, it can then be determined whether a particular utility pole on the telephone utility's map is the same pole as the utility pole on the electric utility's map. Thus, the OX Spatial Index can be used to integrate disparate referencing systems by providing a single absolute positioning system which each system can reference. This eliminates the need for complex task of translating and combining the databases and allows the current system to be used with any GIS system, regardless of the software used.

Thus the current invention provides a simple and inexpensive method for using and coordinating these databases without having to control all of the data in the different databases or combining the databases into a single database. The current invention also encourages parties to cooperate in the sharing of data by allowing them to maintain control over their own data while not disclosing proprietary data.

The present invention thus provides useful information for government functions, town planning, local authority and public utility management, environmental considerations, resource management, engineering, business, marketing, distribution and consumers.

### BRIEF DESCRIPTION OF THE DRAWINGS

FIG. 1 illustrates a parcel bounded by adjacent streets and an alley and having points of interest.

FIG. 2 illustrates a cell having boundaries extended from the original geographic boundaries of the parcel.

FIG. 3 illustrates the parcel after it has been subdivided into new parcels.

FIG. 4 shows the subdivided parcel of FIG. 3 with new cells.

FIG. 5 illustrates a sample user input screen

FIG. 6 illustrates a flow chart showing the creation of the index.

FIG. 7 is a flowchart illustrating the update of the index of the present invention.

FIG. 8 illustrates a flow chart showing a method for providing a user with geographically relevant information using the index.

FIG. 9 illustrates a user connected to the index via the internet.

### DETAILED DESCRIPTION OF THE INVENTION

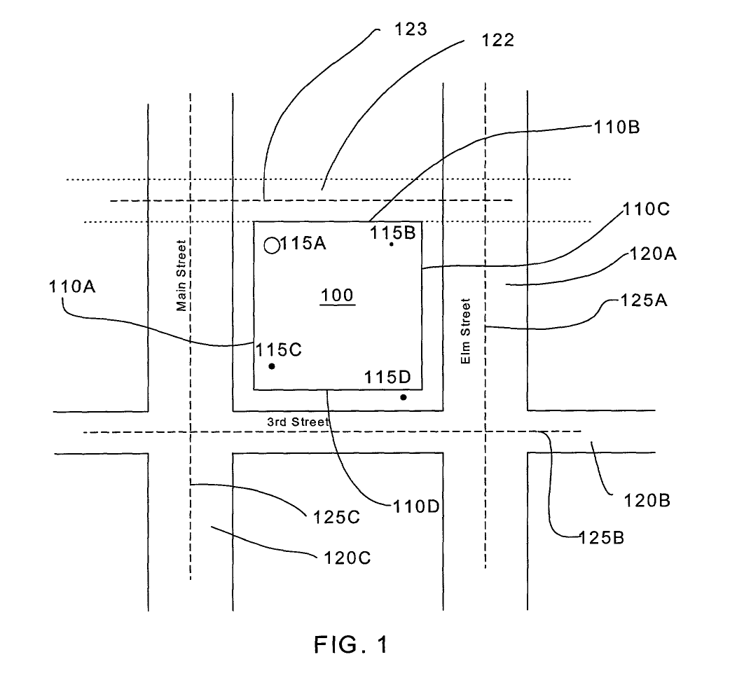

As shown in FIG. 1, a predefined parcel 100 is determined to have boundaries 110A-110D in accordance with a legal description of the land, and is bounded by adjacent streets 120A-C having street centerlines 125A-C and an alley 122 having centerline 123. Parcel 100 has parcel attribute data including, in this example a street address (123 Main St.) of the parcel, utility information, owner information, location of sewer lines, etc., which data is available from various sources, such as utility and government records. As shown in FIG. 1, Parcel 100 has points or areas of interest 115A-115C, which are inside Parcel 100, and point 115D, which lies outside Parcel 100, but which is still part of the parcel's attribute data.

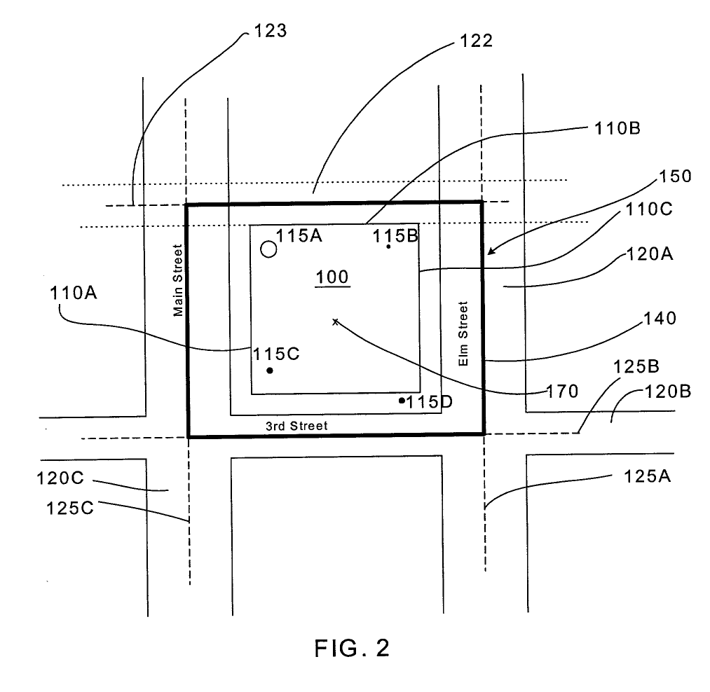

Next, boundaries 110 of parcel 100 are extended to encompass a portion of the adjacent streets 120 and alley 122 (FIG. 2). These extended boundaries define an OX Cell 150 having cell boundaries 140 (FIG. 2). In the preferred embodiment shown in FIG. 2, the boundaries are extended to the centerline 125, 123 of the adjacent streets 120 and alley 122.

For sake of brevity the creation of a single OX Cell is discussed in detail, although the present invention contemplates a sufficient plurality of OX Cells to preferably cover the entire surface of the earth. When two adjacent parcels are separated by a street, the boundaries of each parcel are extended to the street centerline such that each OX Cell thereby created includes the half of the street nearest its associated parcel, thereby incorporating the entire street into cells. In this way, there are no void areas so the entire land surface of the earth may be incorporated into OX Cells. Although in the preferred embodiment the boundaries 110 are extended to the street centerlines 125, it would be obvious to one of ordinary skill in the art to extend the boundaries to some other portion of the street. For example, if the land deed or easement indicates that the land will revert to a particular parcel if the street is closed, then the entire street could be attributed to that particular parcel. As another example, if a street runs east and west between two parcels, the boundaries of the northern parcel may extend some predetermined amount, say 33%, into the street, whereas the boundaries of the southern parcel would extend 67% into the street. In any case, no part of the street is left unassigned. The manner of extending the boundaries is therefore a design choice.

Referring to FIG. 2, OX Cell 150 incorporates parcel 100 and a portion of land outside the parcel. Thus, points or areas of interest 115A-115D are located within the OX Cell 150. Attribute data for both the parcel 100 and the portion of the street (or other area outside the parcel) which is incorporated into the OX Cell 150 is recorded as attribute data for the OX Cell 150.

The OX Cell 150 is assigned a unique identifier. In a preferred embodiment, the unique identifier includes the country, state, township and street address of the parcel for which it is associated. In another embodiment the longitude-latitude system is used.

A reference point 170 (FIG. 2), is determined and assigned to OX Cell 150. The center of mass of OX Cell 150 is determined by calculation from the OX Cell boundaries. Various known methods may be used to determine the center of mass of the OX Cell. In a preferred embodiment software available from Oracle Corporation is used.

The reference point may be the centroid as in prior art GIS systems or it may be some other point. Thus, although in the preferred embodiment point 170 is located at the center of mass of the cell, locations other than the center of mass of the cell may be used. For example, if a well known marker resides within the OX Cell 150, such as a famous statue or monument, the marker location could be used as the reference point. In addition, the reference point 170 may be adjusted in cases where the center of mass falls outside the boundaries of an OX Cell 150, such as where an OX Cell 150 is U-shaped or ring-shaped. In such cases, alternative reference point locations may be used or the OX Cell 150 may be further divided into smaller cells such that a reference point falls within a cell, or the boundaries of the OX Cell could otherwise be adjusted.

The locational address of point 170 is determined within a global referencing system. In a preferred embodiment, the longitude-latitude system is used, but some other global referencing system may be used, such as the Military Grid System.

OX Cell 150 is then assigned a unique global reference address. In a preferred embodiment the global reference address incorporates the locational address within the global referencing system (longitude-latitude) of reference point 170. However, the unique identifier could include other attribute data. Attribute data for the OX Cell 150, such as the parcel street address and other parcel attribute data, as well as attribute data for areas outside parcel 100 which fall within the OX Cell 150 is related to the OX Cell 150, is recorded in the OX Spatial Index 1000 and stored in a relational database.

The attribute data, in addition to the information discussed above, also includes other information, such as what type of structure is on the property, such as a house, a building, or none (a vacant lot), the owner of the property, the locations of utilities, etc. The attribute data preferably includes utility-specific information. For example, many utilities assign a serial number to each power or telephone pole. The attribute data preferably includes this information. The attribute data may also be in various formats such as a series of layers of data overlapping the OX Cell or tables of information. In addition, the associated data may include various types of data in various forms and media, such as but not limited to images, text, audio and video. For example, a company installing an underground utility line on the property can take a digital photograph of the installed line which is then stored in the OX Spatial Index. Public records, such as deeds, can also be digitized, stored in, and made available on the index.

Because there are no voids, the entire surface of the earth is broken down into a plurality of OX Cells 150 such that every geographic location on earth has a corresponding OX Cell 150. Further, each OX Cell 150 has attribute data including a street address or other readily understandable address to the extent such is available. For example, there are remote areas that do not have a street address or even a nearby highway or county road. Thus, in some situations, a non-conventional description of the location of the property may be appropriate, such as “the northernmost island on Atlanta lake. ”

As mentioned above, the OX Spatial Index is stored in a relational database which is made available to a variety of users. Several different tables and methods may be used for storing, indexing, and querying information in the database, as is known to one of ordinary skill in the art. Several different database management systems can be used in connection with the database, such as products available from Oracle Corporation and Informix Corporation.

Although all of the OX Spatial Index may be stored on a single server, it is not necessary to do so. Thus, in another embodiment, public domain information is stored on one server and links are provided to other servers which contain proprietary information. For example, one server contains information regarding parcel owners, street addresses, property lines, etc. which is readily accessible to a variety of users and a separate server contains proprietary information, such as a utility's proprietary locational system, which is only accessible by authorized personnel.

As discussed above, a point or area of interest 115 within an OX Cell 150 (FIG. 2), such as the location of a utility pole, an easement, etc. is stored as attribute data in the OX Spatial Index 1000. The locations of these points 115 are preferably expressed in relation to the location of reference point 170. That is, once the location of reference point 170 in the global reference system is determined, the location of a point or area 115 within the OX Cell 150 is defined in relation thereto. Thus, points 115A-115D (FIG. 2) are recorded as attribute data for the OX Cell 150 with their locations defined in reference to reference point 170. For example, point 115A may be recorded as a utility pole that is located 100 feet north and 50 feet west of reference point 170. In this way, a point of interest can be stored as a subset of the OX Cell 150 in which it resides. Alternatively, the points of interest could be given their own positions in the global referencing system, such as the longitude-latitude system.

It should be noted that OX Cells 150 may have many different shapes and sizes. For example, in rural areas very large OX Cells 150 may be created from large parcels of land, whereas in urban areas smaller OX Cells 150 are more likely due to the smaller parcels typically found. Thus, the index of the present invention is scaleable in that information regarding large tracts of land may be stored in the index. In addition, not every parcel of land will have adjacent streets or predefined addresses as in the example above. Thus, in some cases, such as an interstate highway, an address is created and assigned to the parcel and OX Cell 150. For example, an interstate highway may be broken into OX Cells 150 defining the area between mile markers and assigned an address consisting of the interstate name and the mile markers corresponding to the area incorporated in the OX Cell 150.

In some instances it may be advantageous to further subdivide an OX Cell 150 into a plurality of sub-cells, mini-cells, etc. when a parcel contains a plurality of street addresses, such as when a parcel contains an apartment or office building. In such cases, sub-cells are created to reflect the spatial boundaries of the individual apartments or addresses within the building and may not extend to the street centerline. The term “spatial” in this specification is used in the same sense as the term “locational.”

The steps discussed above in regards to the creation of OX Cells 150 are followed in creating sub-cells. The boundaries of each sub-cell are determined and each sub-cell is assigned a unique identifier, a reference point and a global reference address. The sub-cell's unique identifier is preferably in similar format as the OX Cell 150 in which it resides. For example, it may be the address of the OX Cell 150 with an additional number, such as the suite or apartment number. The distance from the sub-cell reference point and the reference point of the OX Cell in which the sub-cell resides is determined. This distance information and associated data is stored in the OX Spatial Index.

The sub-cells may be created to define various areas such as the various floors of the building, particular street addresses, or some other area definition. The sub-cells may then be even further subdivided into mini-cells, for example to define each office within each floor. Each cell, sub-cell and mini-cell is associated with any larger cell in which it resides.

In cases where two cells, sub-cells, or mini-cells have a reference point at the same location, such as where an inner and outer ring of land have the same center of mass, the “inner” ring is made a child cell (sub-cell, micro-cell) of the “outer” ring cell (cell, sub-cell).

The location of cells and reference points are created in at least two dimensions, and may be created in three dimensions. For example, an x, y, and z coordinate system might use latitude, longitude and altitude relative to sea level. A three dimensional description provides unique global reference points for sub-cells which sit atop one another, such as apartments within an apartment building, individual offices in a multiple floor office building, etc.

As discussed above, attribute data of the OX Cell 150 is recorded in the OX Spatial Index and stored in a relational database. This attribute data is entered into the OX Spatial Index when the index is created. In addition, after creation of the index, attribute data is continually updated with new data.

Because the index contains addresses people can easily understand, such as street addresses, a variety of users can quickly access and/or update attribute data. By way of example, assume a customer calls a utility regarding a power line at a particular property. If the caller provides a street address (a reference which the caller is likely to know) the utility can input the street address into the OX Spatial Index and retrieve information regarding the parcel. If the utility then makes a change to the parcel, such as relocating the utility pole or adding another pole, this information would be recorded in the OX Spatial Index. The utility may take a digital photograph, write a written description, or provide other attribute data associated with the relocation.

An additional component of the attribute data in the OX Spatial Index is quality indicia of the information input into the index, such as the source of the information and the time and date of its input. Thus, when attribute data is entered into the OX Spatial Index quality indicia for the entry is recorded so that a user can reference the quality indicia to decide whether or not to rely on the data. Once the database is updated, the user's identification and the time of entry into the database is automatically recorded and is displayed as part of the attribute data updated by the user. In the example above, the source of the information would be recorded as the utility and the date the information was entered into the index would be recorded.

As changes occur and are entered into the OX Spatial Index, the new data is checked for critical attributes, such as how timely the change is, what the positional accuracy of the change is, how comprehensive the changes are, etc. In this way, quality indicia is maintained for all data thereby providing added assurances for decision makers because the old data may be retrieved and independently compared with the new data to verify the validity of the new data.

The quality indicia is recorded and can be used to certify the accuracy of the data. For example, the quality indicia could be analyzed to determine different levels of quality certification. This may include looking at factors such as how current the data is, the identity of the party which provided the data, comments from users regarding the accuracy of the data, etc. Based upon this analysis, different levels of certification could be provided to the user to indicate data quality. For example, a scale of 1 to 5 could be used with 1 signifying that the data is certified as highly accurate and 5 signifying that the data is unreliable or cannot be verified. This information can then be used to assist users in making decisions whether to rely on the data as well as to identify areas of the OX Spatial Index which need to be updated.

Various security measures can also be used to ensure the accuracy of data entry. For example, when a user attempts to access the OX Spatial Index, the user's identity is verified by some means, such as a password. The user's identity is then used to determine the user's approved access level. If the user has sufficient access privileges, the user is allowed to update the OX Spatial Index. Even if a user has access privileges, those privileges may be limited to a particular state, county, city, or area. For example, a user may have privileges for cells in Atlanta, Ga., USA, but nowhere else.

To further insure the accuracy of the data in the OX Spatial Index periodic reviews are preferably performed of the information stored in the index. For example, the physical sites of the land represented in the index could be reviewed, aerial photographs could be taken, databases containing associated information could be searched, county deed records could be reviewed, etc. in order to check that accuracy of the information in the OX Spatial Index.

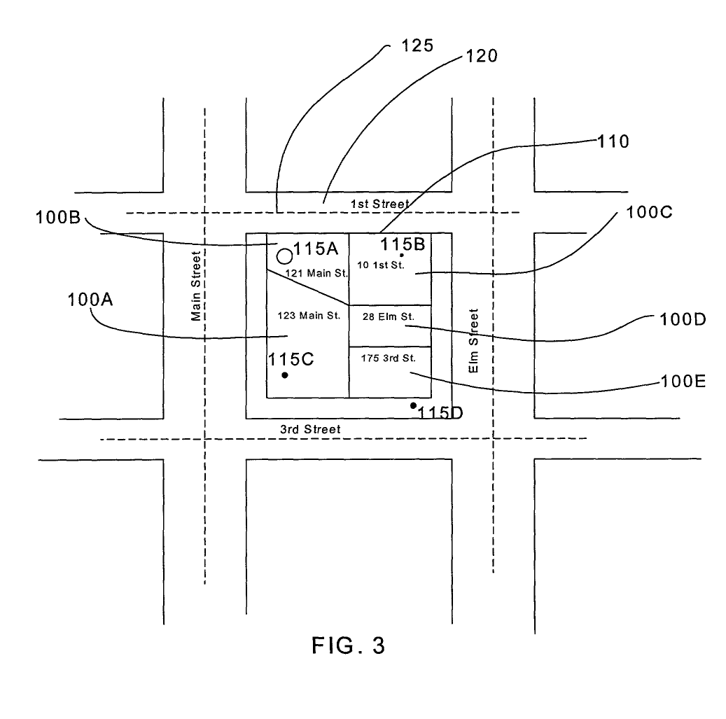

The current invention also provides for updating the OX Spatial Index when other changes, such as changes to parcel boundaries, occur. FIG. 3 shows Parcel 100 at time t2, after it has been subdivided into smaller parcels 100A-100E and alley 122 has been converted into a street 120D. These parcels have associated street addresses: 123 Main St., 125 Main St., 10 First St., 28 Elm St. and 175 Third St., respectively. Thus, the area within OX Cell 150 now has multiple parcels and multiple street addresses.

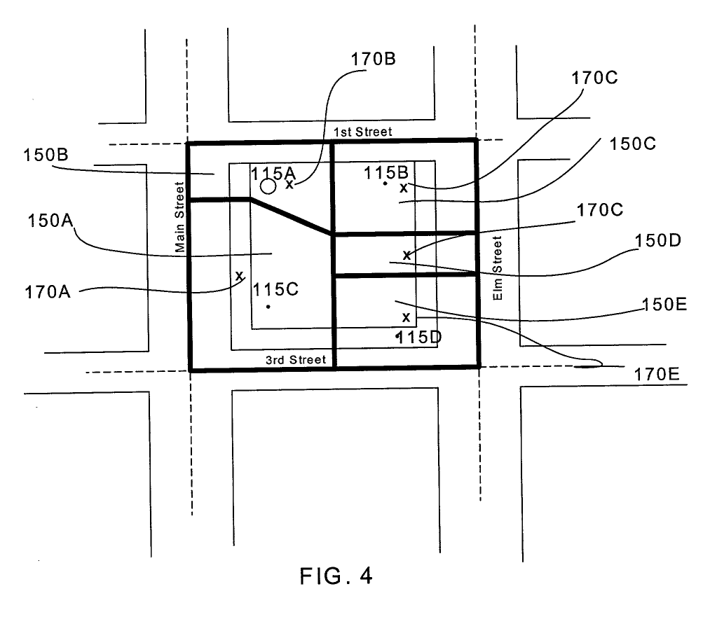

As shown in FIG. 4, the steps set out above in the creation of OX Cell 150 are followed to create new OX Cells 150A, 150B, 150C, 150D and 150E based upon the parcel boundaries 110 (FIG. 2). That is, the boundaries of each of the new parcels 100A-100E are extended to the adjacent street centerlines 125 to create new OX Cells 150A-150E. For each new OX Cell 15ON a reference point 170N and unique identifier are created. Thus, as shown in FIG. 4, OX Cell 150A has reference point 170A, OX Cell 150B has reference point 170B, etc. The geographic boundaries, unique identifiers, and other attribute data (including the new street addresses) are recorded for each new OX Cell 150A-150E. In addition, the source of the information and its date and time of input is also recorded as attribute data.

The location of points of interest 115A-115D are now defined in terms of the reference points of the new OX Cells 150A-150E in which they now reside. Thus, as shown in FIG. 4, point 115A is now within OX Cell 150B, point 115B is within OX Cell 150C, point 115C is within OX Cell 150A and point 115D is within OX Cell 150E. Thus, the location of these points or areas are now referenced to the reference points as follows: 115A to 170B; 115B to 170C; 115C to 170A; and 115D to 170E.

The OX Spatial Index also includes historical data. Thus, the previous information regarding OX Cell 150 is retained in the database and the relationship of each of the newly created OX Cells 150A-150E with the original OX Cell 150 is stored in the database. Thus, it can be readily determined that new OX Cells 150A-150E were previously a part of OX Cell 150. For example, if a query is performed on 123 Main Street (the street address of OX Cell 150 and OX Cell 150A), a user would be provided with attribute data for OX Cell 150A which would include a reference that the address was formerly associated with OX Cell 150. The user may then elect to see the historical attribute information for OX Cell 150, which would indicate that the street address previously included a much larger parcel.

In addition, the current system provides notification of changes to the OX Spatial Index to interested parties. Users may specify criteria within the OX Spatial Index 1000 for which they are interested in receiving updates. For example, an individual may only be interested in updates regarding a parcel of land that he owns whereas a utility may desire to receive update notifications regarding many different type changes, such as changes made by other utilities, for all parcels of land within its service area. The present invention therefore also provides that the identification of interested parties are stored in the OX Spatial Index database, with their notification criteria. When an update to a parcel is made, the update is classified according to one or more of a plurality of notification criteria. For example, notification criteria may include: change of street address; subdivision of parcel; addition of structures to parcel; new easement on parcel; etc. The notification criteria is analyzed, and all parties with that notification criteria will be notified of the update. Further, the new information can be sent with, or instead of, a single notification. Thus, when new information is input into the OX Spatial Index, a notification is sent to all users and producers who desire to update their systems or records regarding that notification criteria. The notification may be sent, depending upon the particular user's preferences, when the new data is received, or when the new data is verified, or both. In a preferred embodiment notifications and updates are transmitted via email but other means may be used.

A transaction log, or history of data changes and updates is kept, including the date and time of the new data, the source of the new data, the accuracy of the new data, a list of persons to whom notifications have been sent, etc. Thus, data owners, and others, who wish to make or review changes to any data which in the OX Spatial Index may look at the transaction log to obtain additional information on the changes that have occurred through time.

Having discussed how cells are created for the OX Spatial Index the creation of Spatial IP addresses (SIP) for these cells will now be described. As part of the OX Spatial Index, each cell (OX Cell, sub-cell, mini-cell, etc.) is assigned a unique SIP which is recorded in the OX Spatial Index and stored in the database. Thus, once an SIP is known, an associated physical location can be determined for the SIP by determining the location of the reference point of the OX Cell 150 associated with the SIP within the OX Spatial Index. In addition, because the index allows for the determination of locations for each SIP, the distance between two SIPs can be determined, that is the location of the reference points associated with each SIP can be determined and the distance between the reference points calculated.

In the preferred embodiment an SIP incorporates the geographical location of the cell. In this way, the location associated with an SIP does not necessitate a table lookup in the database but can be readily determined from the SIP itself. Likewise, the distance between geographical locations associated with SIPs can be readily determined from the SIP itself.

In the preferred embodiment the SIP comprises a top level domain followed by the longitude and latitude coordinates of the OX Cell's reference point 170. For example, the SIP is in the format: top level domain; longitude location; latitude location. In another embodiment the SIP includes other information such as an associated street address or some other associated information. Also, if desired, a request for the physical location of the SIP could result in the street address being provided.

In the preferred embodiment, a sub-cell is assigned an address that is a subset of the SIP of the OX Cell 150 in which it resides. In the preferred embodiment, the additional information is the distance between the OX Cell's reference point 170 and the reference point of the sub-cell, i.e., the SIP of the sub-cell is in the format: top level domain; longitude coordinates of the OX Cell reference point; latitude coordinates of the OX Cell reference point; distance from the OX Cell reference point to the reference point of the sub-cell. The distance between the reference points could be disclosed in a variety of formats or referencing systems.

Likewise, mini-cells are assigned SIPs which are subsets of the parent cells in which they reside, either referencing the sub-cell or OX Cell. In a preferred embodiment, the SIP of a mini-cell would take the format: top level domain; longitude of the OX reference point; latitude of the OX Cell reference point; the distance between the OX Cell reference point and the sub-cell reference point; the distance between the sub-cell reference point and the mini-cell reference point. In another embodiment, the SIP of the mini-cell could take the format top level domain; longitude of the OX reference point; latitude of the OX Cell reference point; distance between the OX Cell reference point and the mini-cell reference point. Other geographically based IP addresses based on other referencing systems such as the Military Grid System can also be used and assigned.

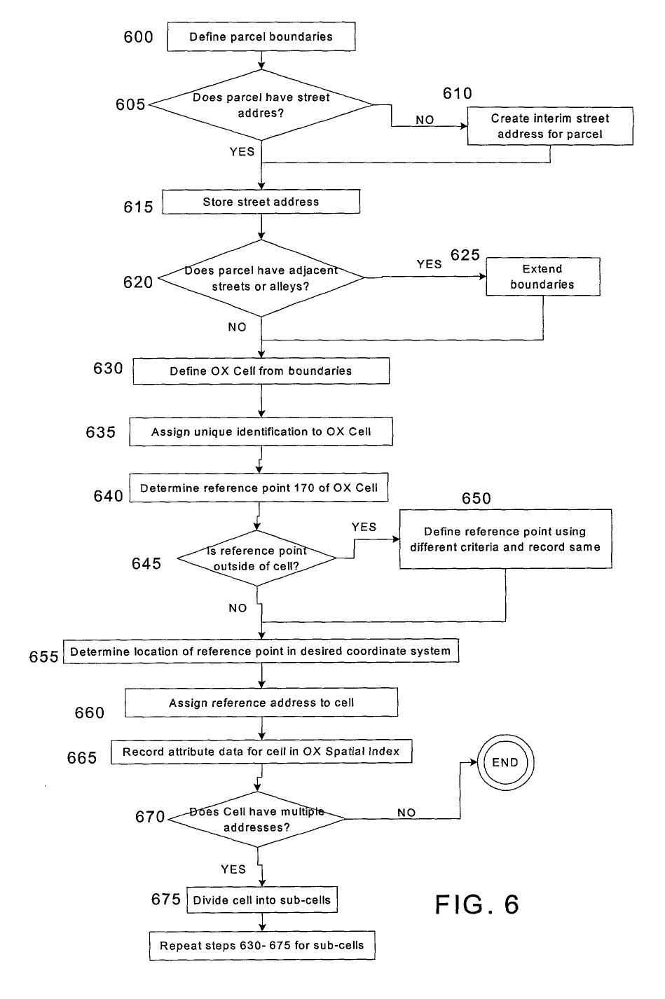

FIG. 6 illustrates a flow chart showing the creation of the index. At step 600 a parcel 100 is defined by boundaries 110. The parcel is reviewed to determine whether it has an associated street address (step 605). If the parcel 100 does not have a street address then an interim street address is created for the parcel (step 610). The street address is then recorded (step 615).

It is then determined whether the parcel 100 has any adjacent streets 120, alleys 122, or other areas which are neither part of the parcel 100 or adjacent parcels (step 620). If there are such streets, alleys, or other outside areas, the boundaries are extended to incorporate a portion of them (step 625). In the preferred embodiment the boundaries are extended to the centerline 125, 123 of street 120 or alley 122. If there are no such areas then the boundaries are not adjusted.

These boundaries 140 define an OX Cell 150 (step 630). A unique identifier is then assigned to the OX Cell 150 (step 635). In the preferred embodiment the unique identifier includes the country, the state, the township, and the street address of the parcel 100. A reference point 170 is then determined for the OX Cell 150 (step 640). In the preferred embodiment the reference point 170 is assigned to the center of mass of the cell, but other positions may be used, as discussed above.

It is then determined whether the reference point is outside the OX Cell (step 645). If the reference 170 point falls outside of the OX Cell 150 then a reference point 170 may be created using some other criteria and this information is recorded (step 650). Various criteria could be used, such as the most northwest point of the cell, the most southern point of the cell, etc.

The location of the reference point 170 within a desired referencing system is then determined (step 655). As discussed above, in the preferred embodiment the longitude-latitude global referencing system is used. After the location of the reference point 170 is determined, a reference address is then assigned to the OX Cell 150 (step 660). In the preferred embodiment the reference address is the location of the reference point 170 within the referencing system (the longitude-latitude system). Attribute data for the OX Cell 150 is recorded in the OX Spatial index (step 665).

It is then determined whether the cell has multiple addresses within in (step 670). For instance, where an apartment building is located on the parcel. If there are multiple addresses then the cell may be further divided into sub-cells (step 675).

The OX Spatial Index can be used for a variety of applications. In one application, the OX Spatial Index is made accessible to users for viewing, updating and reporting and thereby allows parties to obtain accurate spatial data for a parcel of land.

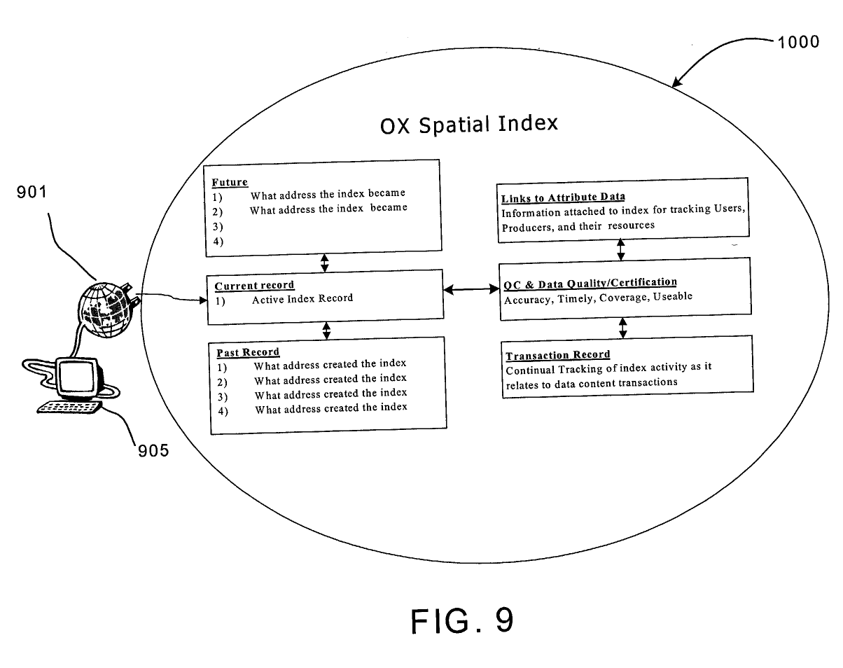

Access to the OX Spatial Index may be accomplished by several means. In the preferred embodiment the index is accessible via the internet. FIG. 9 shows the OX Spatial Index 1000 installed in or connected to a server accessible via the internet 901 by computer 905.

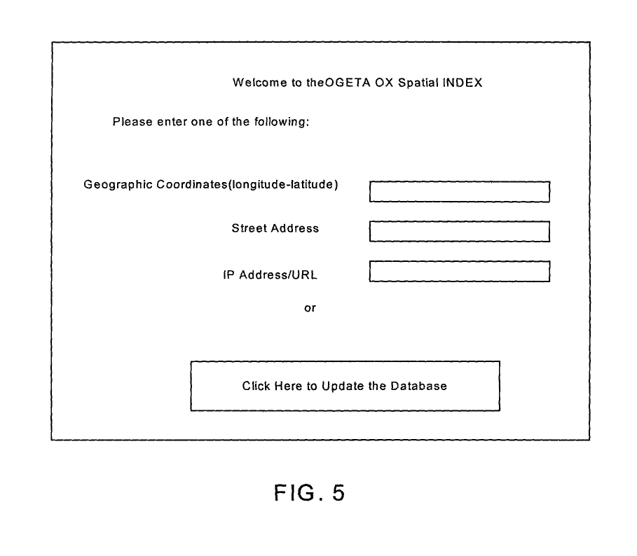

A user at the computer 905 connects to the internet 901 and locates a central website which is connected to the database of the OX Spatial Index 1000. The website provides a display which prompts the user for request information or to indicate that the user wishes to update the database. A sample user screen is shown in FIG. 5. The display preferably provides fields or parameters which can be used to request information or query the database. For example, a display includes one or more entry fields for inserting data known to the user such as a street address, URL/IP Address, geographic coordinates, or other associated information. Various other methods may also be used instead of or in addition to the above-mentioned entry fields. For example, a user could be provided with a map of the world on which the user progressively selects smaller portions to locate the area of interest.

After a user makes a request for information, the request is formatted into a query to the OX Spatial Index 1000 database and a result is determined and displayed to the user.

Also a user may directly connect to a website at the IP address associated with the OX Cell of interest. For example, if a user knows the URL of the parcel of interest, such as the geographic location of the parcel, the user could put the URL/SIP address in an internet search browser and connect to the website associated with that IP address. Also, by using any of the methods described above to connect to the website associated with a parcel, an authorized user can update the data for that parcel. The information provided by the user is then processed at the website.

In the preferred embodiment two or more OX Cells 150 cannot have the same reference point. However, in an alternative embodiment, two or more cells may have the same reference point. In that case a user may be prompted to further identify for which OX Cell 150 he would like the information. Also, a list of the relevant OX Cells 150 could be shown for the user to choose from.

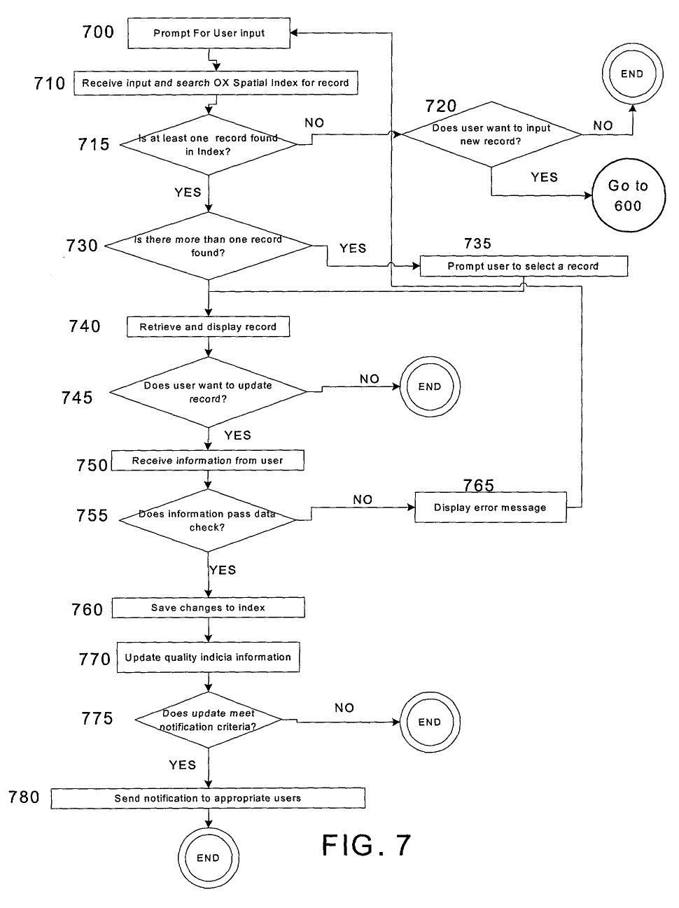

FIG. 7 is a flowchart illustrating the process of updating the index of the present invention. At step 700 a user connects to an interface for the OX Spatial Index, such as that shown in FIG. 9, and is prompted for user input, such as by a user input screen (FIG. 5). The input information is received and the OX Spatial Index 1000 is searched for the record (step 710). For example, the user may enter a URL/SIP address, a street address, geographic coordinates, or other attribute data and the index is searched for record which meet the criteria.

If a record is not found then the user is so informed and prompted whether he would like to enter a new record into the OX Spatial Index (steps 715; 720). If a new record is to be created then the steps of FIG. 6 are followed for creating a new OX Cell 150. If a record is found it is displayed to the user (step 740). If multiple records are found the user is prompted to select which record he would like to view (step 735).

The user is then prompted as to whether he would like to update the record (step 745). If the user elects not to update/edit the record, the user can end the session or be directed to a new search.

If the user elects to edit the record, the user inputs proposed updates to the OX Spatial Index (step 750). Prior to saving these changes a data check is made on the user's input (step 755). For example, the data may be reviewed to determine whether it is geogrphically accurate, such as whether the update contains information which is not related to the geographic area of the record, i.e., the user input is data associated with a location outside of the cell of the current record. If the user's input passes the data check then the changes are saved to the OX Spatial Index (step 760). If the changes do not pass the data check then the changes are rejected and the user is notified of the error (step 765). For example, the user could be supplied with an error message stating: “ERROR—the information you provided is not associated with a location within the cell of this record.” The user may then be prompted to reenter the data.

When the user's changes are saved quality indicia relating to the changes is also saved (step 770). In the preferred embodiment quality indicia including source and time information is recorded and associated with the changes (step 770). Once the changes are recorded, the changes are analyzed to determine whether the changes meet any notification criteria of users (step 775). If such criteria is met, the appropriate users are notified of the changes (step 780).

Various security checks are also performed when a user attempts to update the OX Spatial Index 1000. For instance, a user with read only access will not be allowed to update the OX Spatial Index 1000. In addition, some fields may be confidential and viewable or editable for only a certain class of users. For instance, data related to the location of certin utility lines may be restricted so that only an employee of a particular utility can enter such information.

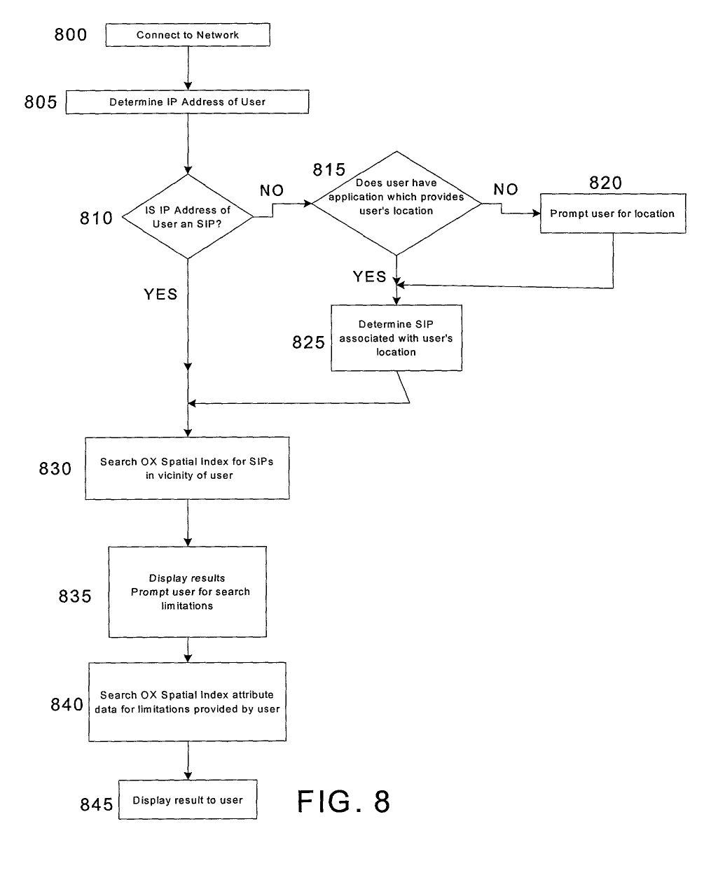

In addition to providing accurate spatial information about an area of land, the OX Spatial Index of the current invention allows for applications which provide geographically relevant data to a specified location, such as the location of the user. FIG. 8 illustrates a flow chart showing a method for providing a user with geographically relevant information using the OX Spatial Index 1000. The user connects to a network on which the OX Spatial Index 1000 resides, such as the network shown in FIG. 9 in which a user uses a computer 905 to connect to the OX Spatial Index 1000 via the internet 910 (step 800). The user could, however, connect by some other device such as a mobile phone, PDA, etc. When the user accesses the OX Spatial Index the user's IP address is determined (step 805) and checked to see whether it is an SIP (step 810). If the user's IP address is an SIP the OX Spatial Index can be searched for SIPs associated with the user's vicinity (step 830). If the user's IP address is not an SIP then the user's physical location is determined, such as from an application on the user's device, such as a locational system on a cell phone (Step 815), or by prompting the user for locational information such as a street address, a global referencing address, etc. (step 820) so that an SIP for the user's location can be determined (step 825).

The OX Spatial Index is then searched based upon the user's SIP, to determine SIPs which are associated with locations within the user's vicinity, such as SIPs which correspond to locations within a one mile radius of the user (step 830). The links to these relevant SIPs are then displayed to the user (step 835). The user may also be prompted to supply additional limitations such as specific geographic requirements, or specific attribute data (step 835). For instance, the user may request Chinese restaurants within a two mile radius of the user. Because the OX Spatial Index 1000 includes attribute data associated with each SIP, SIPs which meet this criteria can be quickly determined by searching the OX Spatial Index (step 840). The results are then displayed to the user (step 845).

The provider of the index may charge a fee for access to the index or for updating or retaining information or being included in the index. For example, the owner of the Chinese restaurant mentioned above could pay a fee to have particular details listed, such as “Mr. Lee's Mandarin Chinese Restaurant” with an address and a telephone number as opposed to a generic “Restaurant” or “Chinese Restaurant” listing with just an address. Also, a charge could be assessed each time that website is accessed by a person as a result of the system or specific details are provided. Likewise, the person searching for the Chinese restaurant could be assessed a fee for accessing the database. Users who provide information, such as utilities, could be paid directly by those users to provide that attribute data or information.

The table below shows sample records of the OX Spatial Index showing sample unique Identifications, the coordinates of the reference point in latitude-longitude coordinates, SIP, and additional attribute data, including the owner of the property, the type of structure on the property, the location of a gas line, and an advertisement for the particular cell.

| Unique Id | Coordinates of Ref. Point | SIP | Owner | Structure | Use | Utility | Advertisement |
|---|---|---|---|---|---|---|---|
| USA Georgia; | 33:45:46N 84:25:21W | ogeta.33:45:46N.84:25:21W | Wei | Business; one | Chinese | Photographs of | “Mr. Lee's |
| Atlanta; | | | Lee | story brick; | restaurant | gas line; | Mandarin Chinese |
| 123 Main St. | | | | photograph | | coordinates, etc | Restaurant” |
| USA, Georgia, | 33:45:47N 84:25:20W | ogeta.33:45:47N.84:25:20W | John | None | | | |
| Atlanta, | | | Smith | | | | |
| 125 Main St. | | | | | | | |
| USA, California, | 37:47:36N 122:33:17W | ogeta.37:47:36N 22:33:17W | David | two story house | residence | | None |
| San Francisco, | | | Jones | | | | |
| 456 Oak St. | | | | | | | |

In addition to geographical distance information, information regarding various zones of interest for each cell can be recorded and provided to users. For example, data regarding school districts, voting districts, emergency service areas for fire stations, hospitals, etc., service areas for various products and services such as cable, DSL, food delivery, etc., flood zones, distances from fire hydrants, etc. are stored in the OX Spatial Index. In a preferred embodiment a separate field is created for each of these data attributes. In addition, the SIP may include information for such zones.

In addition, the OX Spatial Index is useful to insurance companies which insure against utility “cuts.” For example, an insurer which insures an installer of fiber optic cable against the risk of severing a water line, gas line, etc. may require that the installer use and update the OX Spatial Index as a prerequisite for insurance. The use of the index will provide the installer with accurate information prior to installation and thereby decrease the probability of cuts. The index also provides the insurer with information for statistical analysis to determine the risks associated with such installations, such as information regarding geographic locations, proximity to fire stations, proximity to rivers, etc.

Thus, the present invention provides for convenient and reliable creation and updating of information regarding a parcel, and for convenient and reliable accessing of information related to that parcel. The present invention also provides for storing and indexing all available information regarding a parcel, even information in a propriety format.

The current invention also provides an absolute positioning database which can be used as a base upon which relative positioning databases can be built and against which such databases can be referenced. For example, a telephone utility may have a reference to a utility pole in its relative positioning database and an electric utility may have a reference to a utility pole in its relative positioning database. Because each of these databases are based upon relative positioning it is difficult to determine whether the pole referenced in each system is the same pole or a different pole.

As discussed above, attribute data regarding utility poles are recorded in the OX Spatial Index. Included with this data is information regarding what utilities use the pole, such as electric, telephone, cable, etc. and various other features associated with pole. The user can then relate each map to the OX Spatial index can determine if the poles referenced in the different maps are the same pole or different poles. Thus, the OX Spatial Index provides a means for reconciling references in separate databases and determining whether the references identify the same or different objects.

Although in a preferred embodiment these various maps are overlaid, in another embodiment these maps may merely be referenced to the particular absolute position of the OX Spatial Index. For example, a digital photograph could be taken of a particular intersection stored in the OX Spatial Index. Maps, drawings, photographs, etc. for each utility could then be provided to a user one at a time instead of as overlays for this intersection. This eliminates the need to verify that the maps are to scale, or are to the same scale.

Furthermore, because the OX Spatial Index can serve as a base against which other databases are referenced, public domain data could be stored in the OX Spatial Index and a party's proprietary information could be stored in a separate database. For example, a party may want to provide information to others concerning the whereabouts of its underground lines but may not want to disclose any proprietary data. For example, a communications company may want to provide the location of its underground line to prevent the cable from being cut by another party installing some other line but may not want to disclose proprietary data regarding the capacity of the line, the fiber used, the number of lines, etc. In this case, the location of the line could be stored in the OX Spatial Index and made available to users but the proprietary data may be stored on separate database that it is only accessible by authorized parties. Thus, the current system allows for the protection of proprietary data while tying together different systems to a base absolute positioning database. Such protections encourage the cooperative sharing of data by allaying fears of losing proprietary data while providing a means to reduce utility cuts.

In addition to providing information to decrease the likelihood of utility cuts, the OX Spatial Index may also be used for predicting potential service outages. Users of the OX Spatial Index may provide information regarding scheduled work, such as the time and place of a planned installation of an underground cable. This data can then be analyzed to identify areas in which are subject to an increased probability of utility cuts and allow repair crews to plan accordingly. For example, if an installer of fiber optic cable plans to install cable in a particular area, the place and time of such installation is recorded and repair crews can prepare to respond to a utility cut in that area and monitor the situation.

This information may also be used in scheduling the installation of services. For example, if two different utilities both plan to install underground services requiring the digging of a trench, the utilities could coordinate the dig to prevent the necessity of digging in the same area twice and perhaps even use the same conduit for installation. On the other hand, if an electric utility plans to move a utility pole which is shared by a telephone utility, the telephone utility may want to delay installation until after the pole is moved.

Although the present invention has been described with particularity, the invention may be implemented in ways other than the ones described above by a person skilled in the art without departing from the scope of the present invention, as defined by the appended claims.

What is claimed is:

1. A method of spatially indexing land information, comprising the steps of:
selecting a parcel;
defining a cell to include at least a portion of said parcel, said cell having cell boundaries;
assigning a unique identifier and a reference point to said cell, said reference point having a locational address within a global referencing system;
assigning a spatial internet address for said reference point; and
storing said spatial internet address, said unique identifier, said cell boundaries and said locational address for said cell.

2. A method of spatially indexing land information, comprising the steps of:
defining a cell by boundaries;
assigning a unique identifier to said cell;
assigning a reference point to said cell, said reference point having a locational address within a global referencing system;
assigning a spatial internet address for said reference point; and
storing said spatial internet address, said unique identifier, said geographic boundaries and said locational address for said cell.

3. The method of claim 2 wherein said step of defining a cell includes the step of extending a boundary of a predefined parcel of land to a centerline of an adjacent street.

4. The method of claim 2 wherein a boundary for said cell is defined to include at least one centerline for a street.

5. The method of claim 1 or 2 wherein said step of assigning a reference point comprises defining said reference point at the center of said cell.

6. The method of claim 1 or 2 wherein said step of assigning said reference point comprises determining said locational address within a latitude-longitude global referencing system.

7. The method of claim 1 or 2 wherein said step of assigning a unique identifier comprises assigning a street address for said cell.

8. The method of claim 1 or 2 wherein said step of assigning a unique identifier comprises assigning a country, a city, and a state for said cell.

9. The method of claim 1 or 2 wherein said step of assigning a spatial internet address comprises assigning a spatial internet address identifying said reference point.

10. The method of claim 1 or 2 wherein said step of assigning a spatial internet address comprises assigning an address in IPV6 format.

11. A method of spatially indexing land information comprising the steps of:
defining a cell by geographic boundaries;
assigning a unique identifying address to said cell;
assigning a reference point to said cell, said reference point having a locational address within a global referencing system;
assigning a spatial internet address for said reference point, said spatial internet address incorporating said reference point locational address;
collecting associated cell data; and
storing and indexing said spatial internet address, said unique identifier, said geographic boundaries, said locational address and said associated cell data.

12. The method of claim 11 wherein said step of defining a cell comprises defining cell boundaries including at least one street centerline.

13. The method of claim 11 wherein said set of assigning a reference point to said cell comprises assigning a point at a center of said cell.

14. The method of claim 11 wherein said step of assigning a reference point comprises assigning a point in a latitude-longitude referencing system.

15. The method of claim 11 wherein said step of assigning a unique identifier comprises assigning a street address for said cell.

16. The method of claim 11 wherein said step of assigning a unique identifier comprises assigning a country, a city, and a state for said cell.

17. The method of claim 11 wherein said step of assigning a spatial internet address comprises assigning a spatial internet address identifying the geographic location of said reference point.

18. The method of claim 11 wherein said step of assigning a spatial internet address comprises assigning a spatial internet address in IPV6 format.

19. The method of claim 11 wherein said step of storing associated cell data comprises storing metadata.

20. The method of claim 11 wherein said step of storing associated cell data comprises storing a street address.

21. The method of claim 11 wherein said step of storing associated data comprises storing data supplier information.

22. The method of claim 11 wherein said step of storing associated data comprises storing temporal data.

23. The method of claim 11 further comprising the step of receiving cell change data.

24. The method of claim 11 further comprising the step of receiving cell change data wherein said step of receiving cell change data comprises receiving information regarding the supplier of said cell change data.

25. The method of claim 11 further comprising the step of receiving cell change data wherein said step of receiving cell change data comprises receiving information regarding temporal information for said cell change data

26. The method of claim 12 further comprising the step of updating said cell boundaries.

27. A method of spatially indexing land information comprising the steps of:
defining a cell by geographic cell boundaries;
assigning a unique identifying address to said cell;
assigning a reference point to said cell, said reference point having a locational address within a global referencing system;
assigning a spatial internet address for said reference point, said spatial internet address incorporating said locational address of said reference point;
defining sub-cells within said cell by applying a grid of said global referencing system;
assigning a unique identifier to at least one said sub-cell;
assigning a reference point to said at least one sub-cell, said reference point having locational address within said global referencing system;
assigning a spatial internet address to said reference point of said at least one sub-cell;
collecting associated cell and sub-cell data; and
performing at least one of the following:
storing, for said cell, said spatial internet address, said unique identifier, said boundaries, said locational address and said associated cell data; or
storing, for said sub-cell, said spatial internet address, said unique identifier, said boundaries, said locational address and said associated data.

28. The method of claim 27 wherein said spatial internet address for said sub-cell is based upon a subset of said spatial internet address for said cell.

29. The method of claim 27 wherein said step of defining a cell by geographic boundaries comprises extending a boundary of a predefined parcel of land to a centerline of an adjacent street.

30. A method of providing geographic information comprising the steps of:
defining a cell by geographic cell boundaries;
assigning a reference point to said cell, said reference point having a locational address within a global referencing system;
assigning a unique identifying address to said reference point;
assigning a spatial internet address corresponding to said reference point;
collecting associated cell data;
storing and indexing said spatial internet address, said unique identifier, said cell boundaries, said locational address and said associated cell data;
creating a website at said corresponding spatial internet address; and
storing cell data on said website.

31. A method of supplying location based information comprising the steps of:
defining a plurality of cells by geographic boundaries;
assigning a spatial internet address associated with a geographic location of each of said plurality of cells;
creating an index of said plurality of cells and said spatial internet addresses;
determining a user's geographic location;
determining a spatial internet address in a vicinity of said user's geographic location; and
retrieving and presenting at least some data associated with said spatial internet address in vicinity of said user.

32. A method of spatially indexing land information comprising the steps of:
defining a cell by geographic cell boundaries, said cell boundaries including a centerline of an adjacent street;
assigning a unique identifying address to said cell;
assigning a reference point to said cell, said reference point having a locational address within a global referencing system; and
storing and indexing said locational address, said cell boundaries, and said unique identifying address.
